(19) United States
(12) Patent Application Publication
(10) Pub. No.: US 2026/0312108 A1
(43) Pub. Date: Oct. 8, 2026

(54) ION EXCHANGE MEMBRANES

(71) Applicant: Khalifa University of Science and Technology, Abu Dhabi (AE)

(72) Inventors: Emad Alhseinat, Abu Dhabi (AE); Randa Ibrahim Abdelrehim, Abu Dhabi (AE)

(21) Appl. No.: 19/170,470

(22) Filed: Apr. 4, 2025

(51) Int. Cl. H01M 8/1051; H01M 8/1027; H01M 8/1032; H01M 8/1081; H01M 8/22

(52) U.S. Cl. CPC H01M 8/1051; H01M 8/1027; H01M 8/1032; H01M 8/1081; H01M 8/227

(57) ABSTRACT

A membrane includes sulfonated polyethersulfone; humic acid; and a layered aluminosilicate, wherein a weight ratio of humic acid to sulfonated polyethersulfone ranges from about 20:100 to about 30:100, and a weight ratio of the layered aluminosilicate to sulfonated polyethersulfone ranges from about 90:100 to about 100:90. A method for forming a membrane includes mixing a solvent, sulfonated polyethersulfone, and humic acid to form a first mixture; adding a 2-1 layered aluminosilicate to the first mixture to form a second mixture, the 2-1 layered aluminosilicate including a layered structure with an octahedral sheet between two tetrahedral sheets; casting the second mixture; and evaporating the solvent to form a product membrane.

### TECHNICAL FIELD

The subject matter disclosed herein relates to membranes and more particularly to ion exchange membranes and utilization of ion exchange membranes for energy harvesting/generation, desalination, and ion recovery. The present invention further relates to methods for forming such membranes.

### BACKGROUND

Ion exchange membranes (IEMs) are playing an increasingly important role in various applications, with the diverse uses of ion exchange membranes expanding year after year. These ion exchange membranes are polymeric films with charged ionic functional groups that allow the transport of oppositely charged species (counterions) while retaining like-charged ions (co-ions). The significance of membranes in the advancement of operations such as energy harvesting cannot be overstated. One example of an energy harvesting application is reverse electrodialysis (RED). Reverse electrodialysis is used for harnessing energy from the Gibbs free energy of mixing under a salinity gradient. However, achieving optimal selectivity, high performance, and cost-effectiveness remains a key challenge hindering the commercialization of reverse electrodialysis units.

### SUMMARY

According to one aspect, a membrane includes sulfonated polyethersulfone; humic acid; and a layered aluminosilicate, wherein a weight ratio of humic acid to sulfonated polyethersulfone ranges from about 20:100 to about 30:100, and a weight ratio of the layered aluminosilicate to sulfonated polyethersulfone ranges from about 90:100 to about 100:90.

According to another aspect, a method for forming a membrane includes mixing a solvent, sulfonated polyethersulfone, and humic acid to form a first mixture; adding a 2-1 layered aluminosilicate to the first mixture to form a second mixture, the 2-1 layered aluminosilicate including a layered structure with an octahedral sheet between two tetrahedral sheets; casting the second mixture; and evaporating the solvent to form a product membrane.

According to another aspect, a reverse electrodialysis system includes an anode; a cathode; one or more anion exchange membranes; and one or more cation exchange membranes, the one or more cation exchange membranes including a plurality of sulfonated polymers, humic acid, and montmorillonite, wherein a weight ratio of humic acid to the plurality of sulfonated polymers in the one or more cation exchange membranes ranges from about 20:100 to about 30:100.

### BRIEF DESCRIPTION OF THE DRAWINGS

FIG. 1 illustrates a method for forming a membrane, according to some embodiments.

FIG. 2A illustrates a reverse electrodialysis system, according to some embodiments.

FIG. 2B illustrates an electrodialysis system, according to some embodiments.

FIG. 3 illustrates interactions of substances in a membrane, according to some embodiments.

FIG. 4A illustrates X-ray diffraction (XRD) analysis of MMT powder, humic acid (HA), a sulfonated polyethersulfone (SPES) membrane, and a formed membrane of the present disclosure (SHMt), according to some embodiments.

FIG. 4B illustrates X-ray photoelectron spectroscopy (XPS) survey spectra of MMT powder, humic acid (HA), a sulfonated polyethersulfone (SPES) membrane, and a formed membrane of the present disclosure (SHMt), according to some embodiments.

FIG. 4C illustrates high resolution scans for O 1s for a sulfonated polyethersulfone (SPES) membrane, a sulfonated polyethersulfone and humic acid membrane (SH), and a formed membrane of the present disclosure (SHMt), according to some embodiments.

FIG. 4D illustrates high resolution scans for C 1s for a sulfonated polyethersulfone (SPES) membrane, a sulfonated polyethersulfone and humic acid membrane (SH), and a formed membrane of the present disclosure (SHMt), according to some embodiments.

FIG. 4E illustrates thermogravimetric analysis (TGA) for a sulfonated polyethersulfone membrane (SPES), a sulfonated polyethersulfone and humic acid membrane (2.5-SH), a MMT and sulfonated polyethersulfone membrane (10-MS), and a formed membrane of the present disclosure (SHMt), according to some embodiments.

FIG. 5A illustrates proton nuclear magnetic resonance (1H-NMR) of a 10-MS membrane, according to some embodiments.

FIG. 5B illustrates proton nuclear magnetic resonance (1H-NMR) of a SHMt membrane, according to some embodiments.

FIG. 6A illustrates cation selectivity of a SHMt membrane and a PSK cation exchange membrane against ionic species with different hydrated diameters, according to some embodiments.

FIG. 6B illustrates the NaCl salinity gradient-dependent cation selectivity for a SHMt membrane and a PSK cation exchange membrane, according to some embodiments.

FIG. 6C illustrates the current density for a SHMt membrane and a PSK cation exchange membrane in the presence of foulants, according to some embodiments.

FIG. 6D illustrates resistivity across a SHMt membrane and a PSK cation exchange membrane in the presence of foulants, according to some embodiments.

FIG. 6E illustrates long-term stability (cation selectivity) of a SHMt membrane and a PSK cation exchange membrane under a salinity gradient (50-fold), according to some embodiments.

FIG. 6F illustrates long-term stability (power density) of a SHMt membrane and a PSK cation exchange membrane under a salinity gradient (50-fold), according to some embodiments.

FIG. 7A illustrates long-term stability (cation selectivity) of the SHMt membranes compared to a PSK membrane, according to some embodiments.

FIG. 7B illustrates long-term stability (cation selectivity) of the SHMt membranes compared to a PSK membrane, in the presence of Zn(NO₃)₂, according to some embodiments.

FIG. 7C illustrates long-term stability (cation selectivity) of the SHMt membranes compared to a PSK membrane, in the presence of Ni(NO₃)₂, according to some embodiments.

FIG. 7D illustrates long-term stability (cation selectivity) of the SHMt membranes compared to a PSK membrane, in the presence of phenol, according to some embodiments.

FIG. 7E illustrates long-term stability (power density) of the SHMt membranes compared to a PSK membrane, according to some embodiments.

FIG. 7F illustrates long-term stability (power density) of the SHMt membranes compared to a PSK membrane, in the presence of Zn(NO₃)₂, according to some embodiments.

FIG. 7G illustrates long-term stability (power density) of the SHMt membranes compared to a PSK membrane, in the presence of Ni(NO₃)₂, according to some embodiments.

FIG. 7H illustrates long-term stability (power density) of the SHMt membranes compared to a PSK membrane, in the presence of phenol, according to some embodiments.

FIG. 8A illustrates a comparative plot of membrane resistivity and energy conversion efficiency of SHMt, a PSK cation exchange membrane, and other membranes, according to some embodiments.

FIG. 8B illustrates unit cost of raw nanofiller materials per mass (g) or unit cost of membranes per 1 m² area, according to some embodiments.

### DETAILED DESCRIPTION

Embodiments of the present disclosure provide membranes, methods for forming such membranes, and systems capable of utilizing such membranes. Membranes of the present disclosure can be used as ion exchange membranes for various applications, such as electrodialysis, reverse electrodialysis, and metal removal/harvesting applications. For example, while ion exchange membranes can be used for energy conversion, conventional ion exchange membranes suffer from low selectivity or fouling due to challenging environments containing heavy metals or organic contaminants. Ion exchange membranes of the present disclosure exhibit excellent selectivity and fouling resistance, even in the presence of common heavy metals and foulants.

Membranes of the present disclosure include hybrid matrix membranes. Hybrid matrix membranes include material(s) (e.g., nanomaterial(s)) dispersed in a polymeric matrix. The hybrid matrix membrane can include a polymeric material, humic acid, and a layered aluminosilicate. The polymeric material can include a plurality of polymers. For example, the polymeric material can include a plurality of sulfonated polymers. Sulfonated polymers can be formed by introducing (e.g., adding) one or more sulfonic acid groups (—SO3H) to at least a portion of a polymer structure. Examples of sulfonated polymers include sulfonated polyetheretherketone, sulfonated poly vinyl alcohol, sulfonated polysulfone, sulfonated polyvinylidene fluoride, and sulfonated polyethersulfone (SPES). The polymeric material can include one or more polysulfones or modified variants thereof (e.g., sulfonated). Polysulfones are thermoplastics including the aryl-SO₂-aryl subunit. Examples of polysulfones include polysulfone (PSU), polyethersulfone (PES) and polyphenylene sulfone (PPSU).

In one example, the polymeric matrix includes sulfonated polyethersulfone (SPES). Sulfonated polyethersulfone is a modified variant of polyethersulfone (PES), a high-performance thermoplastic polymer. Sulfonated polyethersulfone is a polymer with sulfonic acid functional groups attached to its aromatic rings. Sulfonated polyethersulfone is created by introducing sulfonic acid groups (—SO3H) to the polyethersulfone structure through a process called sulfonation. Sulfonated polyethersulfone exhibits excellent performance for membrane applications of the present disclosure (e.g., electrodialysis, reverse electrodialysis, and metal removal/harvesting) and sulfonated polyethersulfone exhibits desirable compatibility with additional membrane components of the present disclosure (e.g., humic acid and/or layered aluminosilicate).

The sulfonation of polyethersulfone can be performed using sulfonating agents such as chlorosulfonic acid or concentrated sulfuric acid. For example, sulfuric acid may be contacted with dry polyethersulfone to form sulfonated polyethersulfone. The sulfonated polyethersulfone can have varying degrees of sulfonation. The degree of sulfonation can be controlled by the reaction time and the ratio of the sulfonating agent and polymer material. For example, the degree of sulfonation can be greater than 5%, greater than 10%, greater than 20%, or greater than 30%. In one example, the degree of sulfonation can be determined by nuclear magnetic resonance (NMR) spectroscopy. Sulfonation can increase the surface charge of the membrane, making it more negative. Sulfonation can also promote fouling resistance to the membrane, due to the presence of functional groups on the polymer backbone. Accordingly, sulfonated polyethersulfone exhibits excellent thermo-mechanical, oxidative, and chemical stability. Further, in one example, utilizing sulfonated polyethersulfone in the membrane instead of a perfluorosulfonic acid/polytetrafluoroethylene (PTFE) copolymer-based membrane or a fluorinated polymer membrane can reduce the overall cost of the membrane.

Humic acid (HA) includes phenol and carboxylic acid functional groups. The phenol and carboxylic acid functional groups can exhibit deprotonation properties, leading to the release of H⁺ ions. Humic acid includes hydrophilic regions (OH groups) and hydrophobic regions (aliphatic chains and aromatic rings). In one example, humic acids can include phenol, carboxylic acid, and one or more of enolic, quinone, and ether functional groups. Humic acids can also include sugars and peptides. Based on elemental analysis, humic acids can include about 35 to 60% C and about 15 to 30% O (atomic %). Humic acids can include H, N, and S. The H, N and S percentages based on elemental analysis can range from about 20 to 48%, about 0.4 to 4%, and about 0.05 to 1%, respectively (atomic %). Humic acids can have molecular weights ranging from 2.0 to 1300 kDa.

Humic acids can be partially soluble at neutral pH (e.g., pH value of about 7) and substantially soluble in alkaline conditions (pH value greater 7). This solubility can vary depending on the chemical composition and the origin of the humic acid. In alkaline media, phenolic and carboxylic groups are deprotonated, and the repulsion of these negatively charged groups causes the molecules to assume a stretched configuration. Humic acid can be formed from the decomposition of biomass, such as plant and animal matter. Additionally, humic acid can be extracted from peat or coal, or humic acid can be chemically synthesized using polymerization/condensation reactions. Compared with other materials like graphene oxide or carbon nanotubes, humic acid is more environmentally friendly and is much cheaper. By incorporating humic acid into the membrane, the membrane can exhibit enhanced selectivity and fouling resistance. Further, during the membrane formation process, humic acid exhibits excellent dispersion capacity with sulfonated polyethersulfone in the casting solution.

The membrane can include humic acid and a plurality of sulfonated polymers. Tuning the weight ratio of humic acid to the plurality of sulfonated polymers can improve the mechanical strength of the membrane and enhance selectivity. In one example, the weight ratio of humic acid to the plurality of sulfonated polymers ranges from about 15:100 to about 40:100. In another example, the weight ratio of humic acid to the plurality of sulfonated polymers ranges from about 20:100 to about 30:100. In another example, the weight ratio of humic acid to the plurality of sulfonated polymers ranges from about 23:100 to about 27:100. In another example, the weight ratio of humic acid to the plurality of sulfonated polymers is about 25:100.

The membrane can include humic acid and sulfonated polyethersulfone. Tuning the weight ratio of humic acid to sulfonated polyethersulfone can improve the mechanical strength of the membrane and enhance selectivity. In one example, the weight ratio of humic acid to sulfonated polyethersulfone ranges from about 15:100 to about 40:100. In another example, the weight ratio of humic acid to sulfonated polyethersulfone ranges from about 20:100 to about 30:100. In another example, the weight ratio of humic acid to sulfonated polyethersulfone ranges from about 23:100 to about 27:100. In another example, the weight ratio of humic acid to sulfonated polyethersulfone is about 25:100.

The weight ratio of humic acid to sulfonated polyethersulfone can be less than 28:100. In one non-limiting example, utilizing the weight ratio of humic acid to sulfonated polyethersulfone of less than 28:100 improves the overall mechanical strength of the membrane. The weight ratio of humic acid to sulfonated polyethersulfone can be greater than 22:100. In one non-limiting example, utilizing the weight ratio of humic acid to sulfonated polyethersulfone of greater than 22:100 improves membrane selectivity and promotes desirable intercalation.

The membrane includes one or more silicates. Silicates are clay minerals that include silicon and oxygen. The silicates of the present disclosure generally exhibit a layered structure. Accordingly, these silicates of the present disclosure are referred to as layered silicates. At least a portion of polymeric material can be intercalated inside at least a portion of the layered structure of the layered silicate. In one example, other chains of the polymeric material can exhibit a coil structure around the layered structure of the layered silicate.

In one example, the layered silicate is a layered aluminosilicate. Layered aluminosilicates exhibit a layered structure including aluminum, silicon, and oxygen. At least a portion of the aluminum and oxygen in the layered aluminosilicate can be in the form of aluminum oxide (alumina). At least a portion of the silicon in the layered aluminosilicate can be in the form of silicon oxide (silica). Layered aluminosilicates can include Si—O—Al linkages. In one example, the layered aluminosilicate is a 2-1 layered aluminosilicate. A 2-1 layered aluminosilicate includes an octahedral sheet between two tetrahedral sheets. Examples of 2-1 layered aluminosilicates include beidellite, vermiculite, montmorillonite (MMT), and paragonite. In one example, the 2-1 layered aluminosilicate includes montmorillonite.

Montmorillonite is a 2-1 layered silicate mineral where each layer (e.g., −1 nm) includes two O—Si—O tetrahedral sheets sandwiching one O—Al (Mg)—O octahedral sheet. Montmorillonite includes aluminum, silicon, and oxygen atoms. Montmorillonite can include aluminum, silicon, oxygen, and magnesium atoms. Examples of montmorillonite can include sodium montmorillonite, magnesium montmorillonite, and calcium montmorillonite. Accordingly, different forms of montmorillonite can exhibit varying amounts of sodium, magnesium, and/or calcium. For example, montmorillonite can follow the formula (Na,Ca)_{0.3}(Al,Mg)₂Si₄O₁₀(OH)2·n(H₂O). Additionally, or alternatively, other phyllosilicates can be added to the membrane. Phyllosilicates include micas and clay minerals.

In one example, the interlayer spacing of the 2-1 layered aluminosilicate can range from about 0.5 nm to about 3 nm. In another example, the interlayer spacing of the 2-1 layered aluminosilicate can range from about 0.8 nm to about 2 nm. In another example, the interlayer spacing of the 2-1 layered aluminosilicate can range from about 0.8 nm to about 1.5 nm. The layer thickness of the 2-1 layered aluminosilicate can range from about 0.8 nm to about 1.2 nm, and the lateral dimensions can vary from 20 nm to 5 μm. The dimensions of these layers depend on the silicate, the source, and the method of preparation. Therefore, the aspect ratio of the layers can be greater than 1000. Utilizing montmorillonite in the membrane can improve cation selectivity, energy conversion efficiency, and environmental stability. The incorporation of montmorillonite can also enhance the thermal stability of the membrane.

The weight ratio of the layered aluminosilicate to a plurality of sulfonated polymers can be tuned to reduce internal resistance, decrease cost, and increase performance and selectivity. In one example, the weight ratio of the layered aluminosilicate to the plurality of sulfonated polymers ranges from about 85:100 to about 100:85. In another example, the weight ratio of the layered aluminosilicate to the plurality of sulfonated polymers ranges from about 90:100 to about 100:90. In another example, the weight ratio of the layered aluminosilicate to the plurality of sulfonated polymers ranges from about 97:100 to about 100:97. In another example, the weight ratio of the layered aluminosilicate to the plurality of sulfonated polymers is about 100:100.

The weight ratio of the layered aluminosilicate to sulfonated polyethersulfone can be tuned to reduce internal resistance, decrease cost, and increase performance and selectivity. In one example, the weight ratio of the layered aluminosilicate to sulfonated polyethersulfone ranges from about 85:100 to about 100:85. In another example, the weight ratio of the layered aluminosilicate to sulfonated polyethersulfone ranges from about 90:100 to about 100:90. In another example, the weight ratio of the layered aluminosilicate to sulfonated polyethersulfone ranges from about 97:100 to about 100:97. In another example, the weight ratio of the layered aluminosilicate to sulfonated polyethersulfone is about 100:100.

The weight ratio of the layered aluminosilicate to sulfonated polyethersulfone can be less than 100:95. In one non-limiting example, utilizing a weight ratio of the layered aluminosilicate to sulfonated polyethersulfone of less than 100:95 provides enhanced mechanical properties and membrane integrity. The weight ratio of the layered aluminosilicate to sulfonated polyethersulfone can be greater than 95:100. In one non-limiting example, utilizing a weight ratio of the layered aluminosilicate to sulfonated polyethersulfone of greater than 95:100 provides enhanced selectivity, stability, and fouling resistance.

The membrane can include both humic acid and a layered aluminosilicate. The weight ratio of humic acid to layered aluminosilicate can range from about 18:100 to about 30:100. In one example, the weight ratio of humic acid to layered aluminosilicate ranges from about 20:100 to about 28:100. In another example, the weight ratio of humic acid to layered aluminosilicate ranges from about 22:100 to about 28:100. In another example, the weight ratio of humic acid to layered aluminosilicate ranges from about 24:100 to about 26:100.

The polymeric material and humic acid can be at least partially intercalated between layers of the layered aluminosilicate. Intercalation includes the inclusion or insertion of one or more distinct substances into layered structures. Functional groups of humic acid can promote the intercalation process. Humic acid can interact with the layered aluminosilicate through mechanisms such as anion exchange at the edges of layered aluminosilicate particles, cation/water bridging to the layered aluminosilicate surface, hydrogen bonding with Si—OH groups, and/or van der Waals forces. One or more of these interactions can contribute to the at least partial intercalation of the polymeric material and humic acid within layers of the layered aluminosilicate.

Utilizing amounts of the polymeric material, humic acid, and layered aluminosilicate discussed herein can promote expansion of the interlayer in the layered aluminosilicate. Expansion of the interlayer can promote faster ion transport and enhanced ion selectivity. Furthermore, the formation of strong hydrogen bonding and electrostatic interactions between the functional groups of the humic acid and the layers of the layered aluminosilicate can enhance the stability and durability of the intercalated structure. This can lead to improved mechanical properties and resistance to degradation, making the membrane more desirable for long-term applications.

In one example, the membrane includes a layered aluminosilicate, humic acid, and sulfonated polyethersulfone, where the layered aluminosilicate can interact with the humic acid via hydrogen bonding, and the sulfonated polyethersulfone can interact with the humic acid via hydrogen bonding. The combination of the layered aluminosilicate, humic acid, and sulfonated polyethersulfone can enhance the ion selectivity and transport properties of the membrane, enhancing energy conversion efficiency. Further, these membranes can exhibit high selectivity even in the presence of contaminants and foulants.

X-ray photoelectron spectroscopy (XPS) analysis can be used to determine the elemental composition of the membrane. These elements can be present from the polymeric material, humic acid, and layered aluminosilicate. In one example, the atomic percentage of C in the membrane ranges from about 60% to about 80%. In another example, the atomic percentage of C in the membrane ranges from about 68% to about 73%. In one example, the atomic percentage of O in the membrane ranges from about 16% to about 30%. In another example, the atomic percentage of O in the membrane ranges from about 18% to about 23%. In one example, the atomic percentage of S in the membrane ranges from about 0.5% to about 5%. In another example, the atomic percentage of S in the membrane ranges from about 2% to about 4%. In one example, the atomic percentage of Si in the membrane ranges from about 0.05% to about 2%. In another example, the atomic percentage of Si in the membrane ranges from about 0.1% to about 1%.

The membrane can exhibit a tuned nanochannel height for the efficient transport of cations and retention of anions in ion exchange applications. The tuned nanochannel height can boost cation selectivity. In one example, the membranes exhibit a nanochannel height ranging from about 1 nm to about 5 nm. In another example, the membranes exhibit a nanochannel height ranging from about 1 nm to about 3 nm. In another example, the membranes exhibit a nanochannel height ranging from about 1 nm to about 2 nm. In another example, the membranes exhibit a nanochannel height of about 1.5 nm. The membrane can have a thickness of 10 μm to 1 cm. In one example, the membrane has a thickness ranging from 10 μm to 200 μm. The length and width of the membrane can be adjusted according to the desired application. For example, the membrane can have a length of greater than 1 cm, greater than 5 cm, greater than 50 cm, or greater than 100 cm. For example, the membrane can have a width of greater than 1 cm, greater than 5 cm, greater than 50 cm, or greater than 100 cm.

The presence of foulants, such as heavy metals and organic compounds, can significantly hinder the ion transport properties of conventional membranes. Examples of foulants include zinc ions and zinc containing-compounds, nickel ions and nickel-containing compounds, and phenol. These foulants can be common in water utilized in oil or gas production or industrial wastewater. Membranes of the present disclosure demonstrate high cation selectivity even in the presence of these contaminants. For comparison and in one non-limiting example, for a membrane with humic acid and sulfonated polyethersulfone, but without layered aluminosilicate, the comparison membrane has greater internal fluidic transport resistance. Therefore, the membranes of the present disclosure feature lower internal fluidic transport resistance, increasing ionic current and power density.

The membranes of the present disclosure can be utilized for various ion exchange applications. For example, the membranes of the present disclosure can be used as semi-permeable cation exchange membranes for various applications such as electrodialysis for water desalination. Cation exchange membranes are membranes that are selectively permeable to cations, while substantially blocking anions. In one example, the cation exchange membrane can selectively block over 90% of anions. In another example, the cation exchange membrane can selectively block over 95% of anions. Further, these membranes can be used as cation exchange membranes for reverse electrodialysis to generate energy. Membranes of the present disclosure can be used to remove/recover lithium from liquid streams. Additionally, these membranes can be used as a cation exchange membrane in a fuel cell.

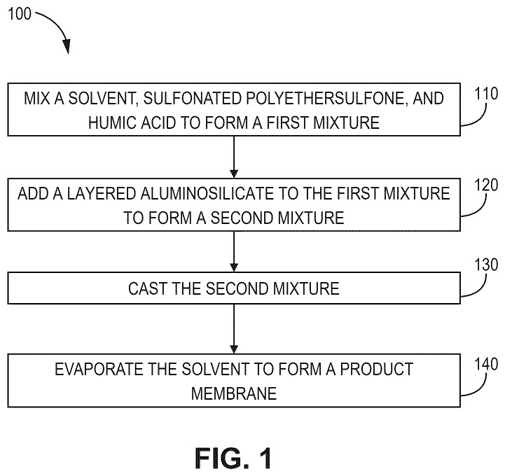

FIG. 1 illustrates a method for forming a membrane, according to some embodiments. Referring to FIG. 1, a flow chart diagram of method 100 for forming a membrane is shown, according to some embodiments. Method 100 includes one or more of the following aspects (with various orders possible):

A solvent, sulfonated polyethersulfone, and humic acid are mixed 110 to form a first mixture. Mixing 110 can include contacting, stirring, heating, and/or placing in physical contact. The solvent, sulfonated polyethersulfone, and humic acid can be mixed simultaneously or in various orders. In one example, the solvent is mixed with the sulfonated polyethersulfone; then humic acid is added. In another example, the solvent is mixed with humic acid; then sulfonated polyethersulfone is added. In another example, the solvent is mixed with humic acid; additional solvent is mixed with sulfonated polyethersulfone, and the two mixtures are combined. The solvent, sulfonated polyethersulfone, and humic acid can be homogeneously mixed. Other polymeric materials of the present disclosure can be used alternative to, or in addition to, the sulfonated polyethersulfone.

The solvent, sulfonated polyethersulfone, and humic acid can be mixed for a period of time sufficient for the first mixture to be in the form of a solution. In one example, the solvent, sulfonated polyethersulfone, and humic acid are mixed for more than 30 minutes, more than 1 hour, more than 4 hours, or more than 10 hours. The solvent, sulfonated polyethersulfone, and humic acid can be mixed at various temperatures, such as at about room temperature (e.g., about 20° C.). In one non-limiting example, method 100 can form membranes without utilizing water and/or a non-solvent.

The solvent includes one or more polar solvents. In one example, the polar solvent includes at least one of tetrahydrofuran (THF), N-methyl-2-pyrrolidone (NMP), Dimethylformamide (DMF), Dimethylacetamide (DMAc), and Dimethyl sulfoxide (DMSO). In one non-limiting example, the polar solvent includes N-methyl-2-pyrrolidone (NMP). NMP is a versatile solvent with high polarity, and NMP is miscible in water. NMP can be produced by an ester-to-amide conversion process. NMP also exhibits high chemical and thermal stability. The high polarity and excellent stability of NMP can ensure NMP is an effective solvent for methods of the present disclosure. The sulfonated polyethersulfone and humic acid include sulfonated polyethersulfone and humic acid as discussed herein.

Tuning the weight ratio of humic acid to sulfonated polyethersulfone can improve mechanical strength of the membrane and enhance selectivity. In one example, the weight ratio of humic acid to sulfonated polyethersulfone in the first mixture ranges from about 15:100 to about 40:100. In another example, the weight ratio of humic acid to sulfonated polyethersulfone in the first mixture ranges from about 20:100 to about 30:100. In another example, the weight ratio of humic acid to sulfonated polyethersulfone in the first mixture ranges from about 23:100 to about 27:100. In another example, the weight ratio of humic acid to sulfonated polyethersulfone in the first mixture is about 25:100.

The weight ratio of humic acid to sulfonated polyethersulfone in the first mixture can be less than 28:100. In one non-limiting example, utilizing the weight ratio of humic acid to sulfonated polyethersulfone in the first mixture of less than 28:100 improves the overall mechanical strength of the membrane. The weight ratio of humic acid to sulfonated polyethersulfone in the first mixture can be greater than 22:100. In one non-limiting example, utilizing the weight ratio of humic acid to sulfonated polyethersulfone in the first mixture of greater than 22:100 improves membrane selectivity and promotes desirable intercalation.

A layered silicate is added 120 to the first mixture to form a second mixture. In one aspect, a layered aluminosilicate is added 120 to the first mixture to form a second mixture. Adding the layered aluminosilicate to the first mixture can include mixing the layered aluminosilicate with the first mixture. Mixing can include contacting, stirring, heating, and/or placing in physical contact. The layered aluminosilicate includes one or more layered aluminosilicates of the present disclosure. The first mixture and layered aluminosilicate can be mixed for a period of time sufficient for the second mixture to be in the form of a solution. In one example, the first mixture and layered aluminosilicate are mixed for more than 30 minutes, more than 1 hour, more than 4 hours, or more than 10 hours. The first mixture and layered aluminosilicate can be mixed at various temperatures, such as at about room temperature (e.g., about 20° C.).

The layered aluminosilicate can be added in the form of layered aluminosilicate powder. In one example, the layered aluminosilicate powder has a mean particle size in a range of between 0.01 and 100 μm. In another example, the layered aluminosilicate powder has a mean particle size in a range of between 0.01 and 20 μm. In another example, the layered aluminosilicate powder has a mean particle size in a range of between 0.01 and 10 μm. In another example, the layered aluminosilicate powder has a mean particle size of less than about 20 μm. In another example, the layered aluminosilicate powder has a mean particle size of less than about 5 μm. For the purposes hereof, the term “mean particle size” refers to a cumulative weight average value (d₅₀) in which 50% of the particles are larger than the value, and 50% of the particles are smaller than the value. Particle size can be determined by laser light diffraction. The shape of the layered aluminosilicate powder particles can be in an aspherical shape, such as plate-like.

By performing mixing 110 before addition 120, the humic acid and sulfonated polyethersulfone can be mixed prior to adding the layered aluminosilicate. Mixing the humic acid and sulfonated polyethersulfone before adding the layered aluminosilicate can promote homogeneous mixing of the humic acid and sulfonated polyethersulfone. This promotes interactions between the humic acid and sulfonated polyethersulfone, such as hydrogen bonding and cation exchange. In one non-limiting example, membranes formed by performing mixing 110 before addition 120 exhibit better ion selectivity performance and mechanical properties compared to a membrane formed by simultaneously mixing humic acid, sulfonated polyethersulfone, and the layered aluminosilicate.

The second mixture is cast 130. The second mixture can be cast on a plate (e.g., glass plate). Casting can include using a casting knife. In one example, the second mixture is cast to a thickness of 50 μm to 500 μm. In another example, the second mixture is cast to a thickness of 50 μm to 200 μm. In another example, the second mixture is cast to a thickness of 75 μm to 150 μm. While casting 130 may not always be required, it can be desirable to use casting to obtain desirable membrane thicknesses for ion exchange membranes.

The solvent is evaporated 140 to form a product membrane. The solvent is generally at least partially evaporated. The solvent can be evaporated at elevated temperatures using a vacuum system. Alternatively, the solvent can be evaporated under nitrogen atmosphere. In one example, the solvent is evaporated at a temperature of greater than 40° C. In another example, the solvent is evaporated at a temperature of greater than 50° C. In another example, the solvent is evaporated at a temperature of greater than 60° C. Evaporation 140 can be performed simultaneously with, or after, casting 130.

Method 100 can efficiently form membranes of the present disclosure for various ion exchange applications. In one non-limiting example, compared to phase inversion using water and an exchange between a solvent and non-solvent, method 100 forms a membrane with enhanced selectivity. The membranes with a combination of polymeric material, humic acid, and layered aluminosilicate exhibit enhanced selectivity for monovalent cations and increased energy conversion efficiency. The incorporation of the layered aluminosilicate can significantly enhance the fouling resistance and membrane stability.

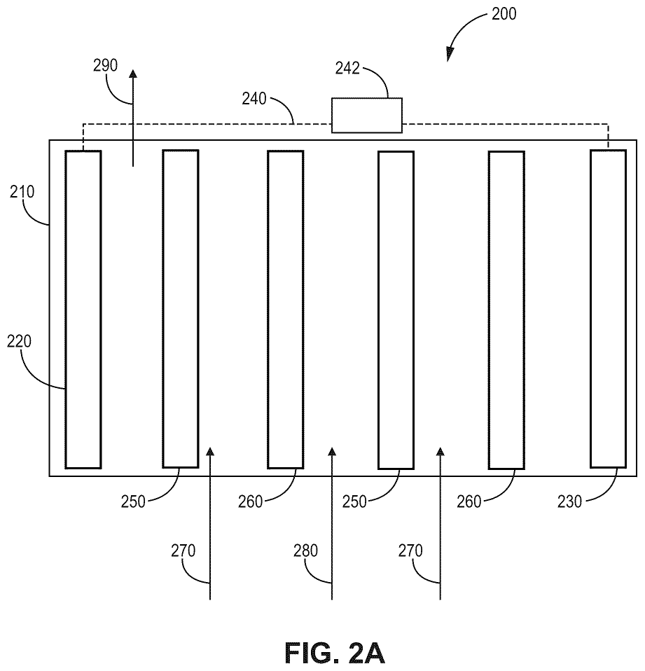

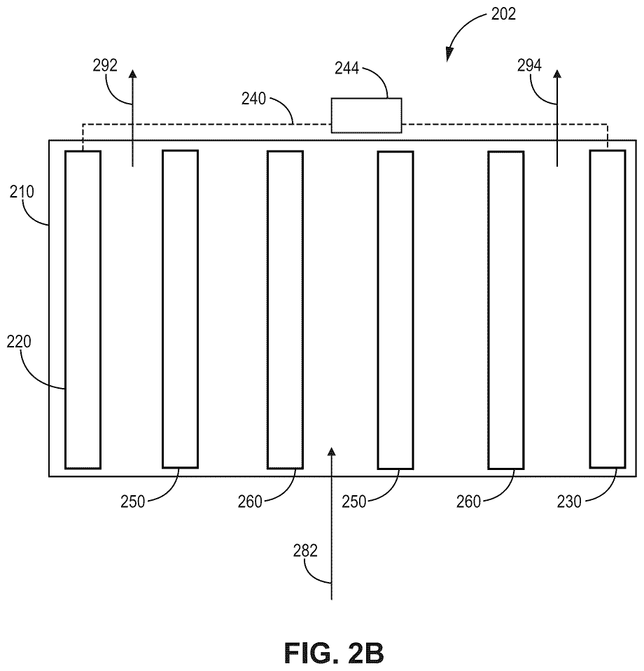

FIG. 2A illustrates a reverse electrodialysis system, according to some embodiments. Reverse electrodialysis system 200 is capable of generating electricity from salinity gradients. Reverse electrodialysis system 200 includes vessel 210, anode 220, cathode 230, electrical connection 240, electrical apparatus 242, anion exchange membrane 250, cation exchange membrane 260, first feed stream 270, second feed stream 280, and exit stream 290. Reverse electrodialysis system 200 utilizes one or more anion exchange membranes and one or more cation exchange membranes between electrodes to generate electricity from salinity gradients.

Vessel 210 includes a structure for permitting the flow of liquid across anion exchange membrane 250 and cation exchange membrane 260. For example, vessel 210 can be used to contain liquid(s) used within reverse electrodialysis system 200, such as liquid(s) provided by first feed stream 270 and second feed stream 280. Anode 220, cathode 230, anion exchange membrane 250, and cation exchange membrane 260 can be positioned within vessel 210. Vessel 210 can include one more inlets and one or more outlets for fluid flow. Vessel 210 can be in fluid communication with one or more liquid pumps for transferring liquid(s) into or out of vessel 210.

Anode 220 facilitates an oxidation reaction, where oxygen gas can be produced. The oxidation reaction at anode 220 can drive movement of ions through the membranes, creating an electrical current. Anode 220 generally includes one or more electrodes. Examples of anode materials include titanium-containing anodes and graphite containing anodes. Examples of titanium-containing anodes include titanium coated with one or more mixed metal oxides, platinized titanium, and titanium coated with ruthenium. In another example, anode 220 includes a silver-based electrode, such as Ag/AgCl.

Cathode 230 facilitates a reduction reaction, where hydrogen gas can be produced. The reduction reaction can allow for the completion of the electrical circuit, providing a pathway for electrons to flow from anode 220 to cathode 230. Cathode 230 generally includes one or more electrodes. Examples of cathode materials include stainless steel, carbon-based cathodes, and titanium-containing cathodes. One examples of a carbon-based cathode is graphite. One example of a titanium-containing cathode includes titanium coated with one or more mixed metal oxides. In another example, cathode 230 includes a silver-based electrode, such as Ag/AgCl. Cathode 230 can be in electrical communication with anode 220.

Anion exchange membrane 250 allows the selective transport of anions, while substantially rejecting cations. Anion exchange membrane 250 can include positively charged groups bound to a polymeric backbone, such as in the presence of water. Anion exchange functional groups can be either strongly basic, such as tertiary ammonium, or weakly basic, such as primary, secondary or tertiary amine groups. Examples of polymeric materials used in anion exchange membrane 250 include polysulfone, polyether ether ketone, and polyether sulfone ketone. While two anion exchange membrane 250 are shown in FIG. 2A, reverse electrodialysis system 200 can include one anion exchange membrane 250, or more than two anion exchange membrane 250.

Cation exchange membrane 260 allows the selective transport of cations, while substantially rejecting anions. Cation exchange membrane 260 includes a membrane of the present disclosure. Compared to membranes made of a copolymer of poly(tetrafluoroethylene) and polysulfonyl fluoride vinyl ether, cation exchange membrane 260 is highly efficient for reverse electrodialysis and is lower cost. While two cation exchange membrane 260 are shown in FIG. 2A, reverse electrodialysis system 200 can include one cation exchange membrane 260, or more than two cation exchange membrane 260. Anion exchange membrane 250 and cation exchange membrane 260 are generally positioned in an alternating orientation within vessel 210. Anion exchange membrane 250 and cation exchange membrane 260 are generally separated by liquid(s).

First feed stream 270 includes a liquid having a greater concentration of salt in the liquid compared to second feed stream 280. Therefore, first feed stream 270 includes a liquid having a greater salinity compared to second feed stream 280. The liquid can include water. The salt can be present as one or more salt ions. Examples of salt ions include sodium, chloride, magnesium, sulfate and calcium. In one example, first feed stream 270 includes seawater. First feed stream 270 can include a liquid having a salt concentration of greater than 5 g/L. In one example, first feed stream 270 includes a liquid having a salt concentration of greater than 15 g/L. In another example, first feed stream 270 includes a liquid having a salt concentration of greater than 30 g/L. First feed stream 270 can exhibit a salinity of greater than 4 times the salinity of second feed stream 280. First feed stream 270 can exhibit a salinity of greater than 10 times the salinity of second feed stream 280. First feed stream 270 can exhibit a salinity of greater than 40 times the salinity of second feed stream 280.

Second feed stream 280 includes a liquid having a lower concentration of salt in the liquid compared to first feed stream 270. Therefore, second feed stream 280 includes a liquid (e.g., water) having a lower salinity compared to first feed stream 270. Therefore, reverse electrodialysis system 200 can harness energy from the Gibbs free energy of mixing under a salinity gradient. The liquid in second feed stream 280 can include water. Second feed stream 280 can include a liquid having a salt concentration of less than 3 g/L. In one example, second feed stream 280 includes a liquid having a salt concentration of less than 1 g/L.

First feed stream 270 and second feed stream 280 can each be introduced into vessel 210 at various positions. First feed stream 270 and second feed stream 280 are generally introduced into vessel 210 sufficient for liquid to be introduced adjacent to at least one of anion exchange membrane 250 and cation exchange membrane 260. First feed stream 270 and second feed stream 280 can each be introduced into vessel 210 using one or more liquid pumps. While first feed stream 270 and second feed stream 280 are illustrated in FIG. 2A as being introduced in a parallel flow orientation, first feed stream 270 and second feed stream 280 can alternatively be introduced in a counter-current flow orientation. After introduction of first feed stream 270 and second feed stream 280 adjacent to at least one of anion exchange membrane 250 and cation exchange membrane 260, cations and anions can substantially flow in opposite directions.

The presence of anion exchange membrane 250 and cation exchange membrane 260 allows the production of renewable energy by converting the salinity gradient into an ionic current and, secondly, into electricity using the electrodes (anode 220 and cathode 230). Anode 220 and cathode 230 can be in electrical communication via electrical connection 240. Electrical connection 240 allows a circuit to be formed from anode 220 to cathode 230 using an external circuit. Electrical apparatus 242 can be used as an electrical load, where the electrons can be used to power the electrical load. During production of electricity, one or more fluid streams can be formed and can exit vessel 210. Exit stream 290 includes liquid(s) and can exit vessel 210 via one or more outlets. The liquid can include water. While one exit stream 290 is illustrated in FIG. 2A, reverse electrodialysis system 200 can include more than one exit stream 290.

The performance of ion exchange membranes in reverse electrodialysis applications can be influenced by one or more of electrical resistance, permselectivity, and biofouling propensity. Enhancing these characteristics can improve the cost-effectiveness and energy efficiency of the reverse electrodialysis process. Membranes of the present disclosure exhibit enhanced ion selectivity and energy conversion efficiency compared to conventional ion exchange membranes. Further, these membranes exhibit improved fouling resistance. Therefore, the membranes can be used for longer periods of time without replacement.

FIG. 2B illustrates an electrodialysis system, according to some embodiments. Electrodialysis system 202 is capable of at least partially desalinating saline water using electricity. Electrodialysis system 202 can utilize electricity and ion exchange membranes to separate salts from water. Accordingly, electrodialysis system 202 can produce desalinated water and a concentrated brine. Electrodialysis system 202 includes vessel 210, anode 220, cathode 230, electrical connection 240, electrical apparatus 244, anion exchange membrane 250, cation exchange membrane 260, saline feed stream 282, concentrate stream 292, and product stream 294.

Each of the vessel 210, anode 220, cathode 230, anion exchange membrane 250, and cation exchange membrane 260 in electrodialysis system 202 can include one or more features, configurations, materials, and/or orientations as discussed for the components used in reverse electrodialysis system 200. Anode 220 can include one or more carbon-based materials or titanium-containing materials. Cathode 230 can include one or more carbon-based materials or titanium-containing materials. In one example, cation exchange membrane 260 includes sulfonated polyethersulfone, humic acid, and layered aluminosilicate.

Saline feed stream 282 can be introduced into vessel 210 between anion exchange membrane 250 and cation exchange membrane 260. While one saline feed stream 282 is shown in FIG. 2B, more than one saline feed stream 282 can be utilized. Saline feed stream 282 can include saline liquid(s) (e.g., seawater). The liquid can include water. The salt can be present as one or more salt ions. Examples of salt ions include sodium, chloride, magnesium, sulfate and calcium. Saline feed stream 282 can include a liquid having a salt concentration of greater than 5 g/L. In one example, saline feed stream 282 includes a liquid having a salt concentration of greater than 15 g/L. In another example, saline feed stream 282 includes a liquid having a salt concentration of greater than 30 g/L. Saline feed stream 282 can be provided to electrodialysis system 202 using one or more liquid pumps.

Electrical apparatus 244 is electrically connected to anode 220 and cathode 230. In one example, electrical apparatus 244 includes a power supply. Voltage is applied between anode 220 and cathode 230, and electrons flow from cathode 230 to anode 220. An electrical potential difference is utilized in combination with anion exchange membrane 250 and cation exchange membrane 260 to separate ionic species. Accordingly, as saline feed stream 282 is introduced within electrodialysis system 202, negative and positive ions originally in saline feed stream 282 can be separated from water to form concentrate stream 292 and product stream 294. Product stream 294 includes the desirable desalinated (e.g., at least partially desalinated) water. Product stream 294 has a lower salinity than both saline feed stream 282 and concentrate stream 292. Concentrate stream 292 and product stream 294 can each be transferred out of electrodialysis system 202 using one or more liquid pumps.

Concentrate stream 292 generally includes liquid having a greater salinity compared to saline feed stream 282. Concentrate stream 292 can include a liquid having a salt concentration of greater than 5 g/L. In one example, concentrate stream 292 includes a liquid having a salt concentration of greater than 15 g/L. In another example, concentrate stream 292 includes a liquid having a salt concentration of greater than 30 g/L. Product stream 294 includes one or more liquids. The liquid in product stream 294 can include water. Product stream 294 can include a liquid having a salt concentration of less than 3 g/L. In one example, product stream 294 includes a liquid having a salt concentration of less than 1 g/L. In another example, product stream 294 includes a liquid having a salt concentration of less than 500 mg/L.

Membranes of the present disclosure can be used to selectively recover monovalent cations from a liquid. For example, the membrane can be utilized to separate lithium (e.g., Li⁺ions) from liquid(s), such as complex brines, such as brines including sodium, magnesium, zinc, calcium, and/or potassium. In one non-limiting example, the membrane exhibits a preference for monovalent cations compared to divalent cations, exhibiting size-dependent steric sieving and electrostatic repulsion. Therefore, the membrane can at least partially separate lithium from a liquid feed stream including lithium and one or more of magnesium (e.g., Mg²⁺ ions) and zinc (e.g., Zn²⁺ ions). The liquid feed stream can include water. Enhanced hydrophobic properties of the membrane can cause higher rejection (lower selectivity) for divalent ions, enhancing the separation of monovalent ions, such as lithium ions.

Importantly, membranes of the present disclosure exhibit enhanced ion selectivity in ion exchange applications. These membranes can be used as cation exchange membranes for various applications, such as electrodialysis to desalinate water and for reverse electrodialysis to generate energy. Further, membranes of the present disclosure can be used to remove/recover lithium from liquid streams. These membranes also exhibit improved fouling resistance—making these membranes desirable for applications that utilize liquids having one or more common foulants. Due to the improved fouling resistance, the membrane can exhibit enhanced selectivity and low resistance for longer periods of time, reducing the operating costs in ion exchange applications.

### Example 1—Preparation of Membrane

A hybrid matrix membrane was prepared using solvent evaporation. First, a polymer concentration of 10% sulfonated polyethersulfone (SPES) was blended with 2.5 wt. % humic acid (HA) for 24 hours. Then, 10 wt. % of montmorillonite (MMT) powder was incorporated into the polymer solution and stirred for 24 hours. Then, the polymer solution was cast to a thickness of 100 m on a clean glass plate and placed in a vacuum oven at 70° C. for 24 hours. The resulting nanocomposite membrane was denoted as SHMt with S, H, and Mt representing SPES, HA, and MMT.

### Example 2—Membrane Component Interactions During and after Preparation

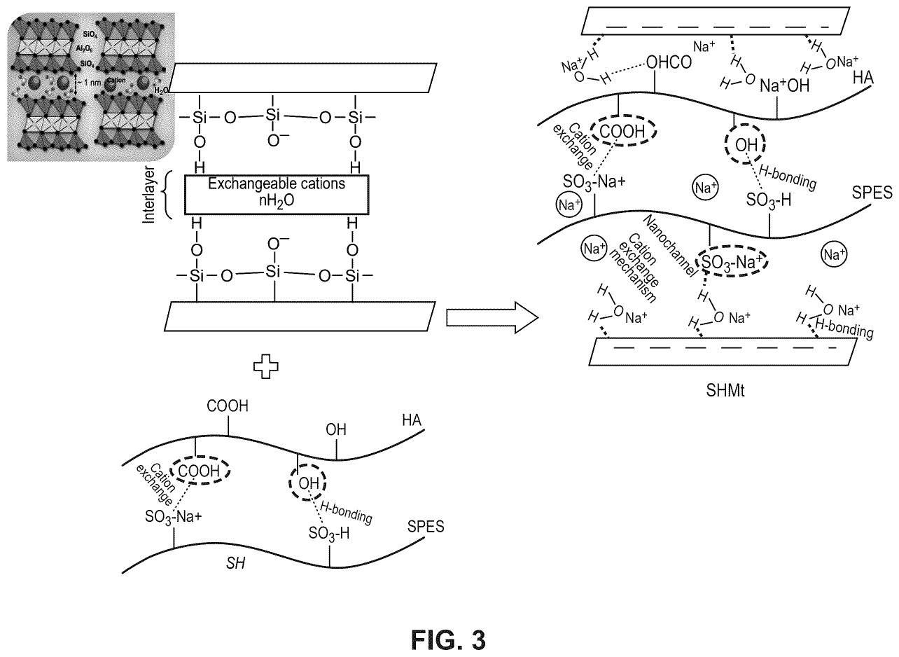

FIG. 3 illustrates interactions of substances in a membrane, according to some embodiments. Sulfonated polyethersulfone can be mixed with humic acid (e.g., in the presence of a solvent) to promote interactions between at least a portion of the sulfonated polyethersulfone and at least a portion of the HA, forming “SH”. For example, hydrogen bonding interactions can be present between a hydroxyl group of HA and a sulfonic group of sulfonated polyethersulfone. Then, SH can be mixed with MMT (e.g., in the presence of a solvent) to form SHMt. SHMt includes HA and sulfonated polyethersulfone at least partially intercalated in MMT. Functional groups of HA can promote the intercalation process. HA can interact with the MMT through mechanisms such as anion exchange at the edges of MMT particles, cation/water bridging to the MMT surface, hydrogen bonding with Si—OH groups, and/or van der Waals forces. One or more of these interactions can contribute to the at least partial intercalation of the sulfonated polyethersulfone and HA within layers of the MMT.

### Example 3—Membrane Characterization

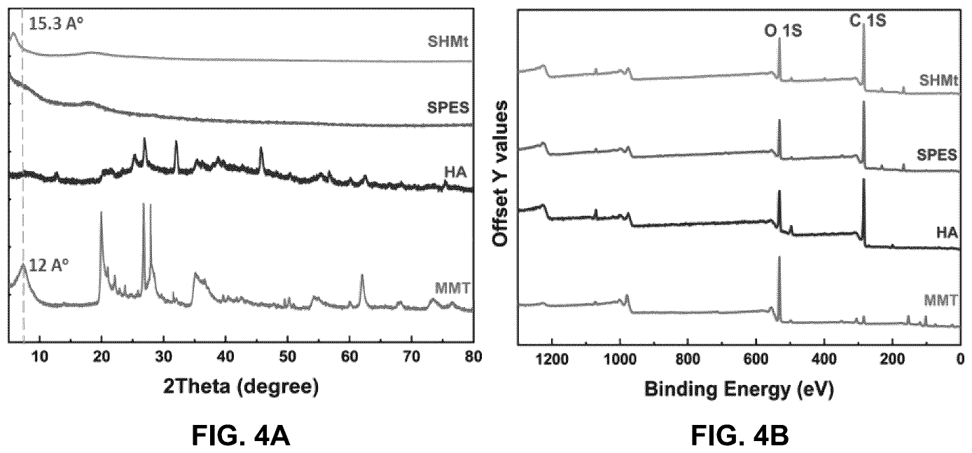

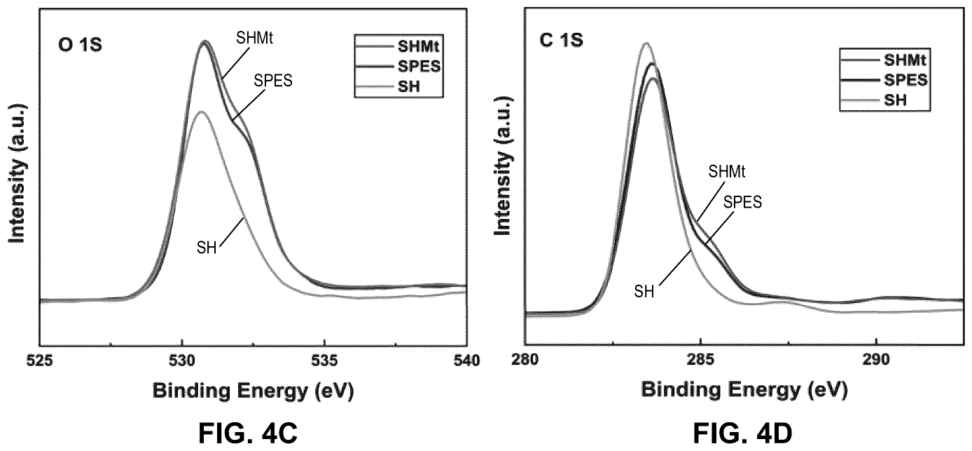

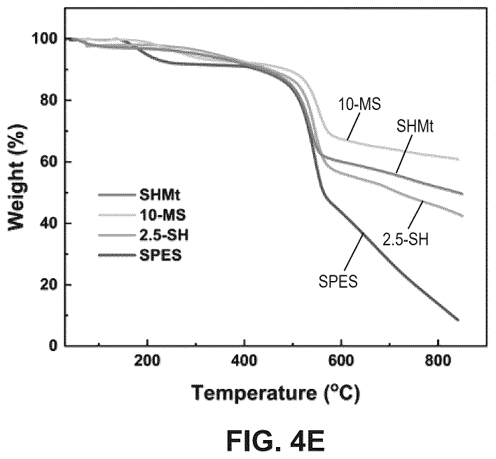

FIG. 4A illustrates X-ray diffraction (XRD) analysis of MMT powder, humic acid (HA), a sulfonated polyethersulfone (SPES) membrane, and a formed membrane of the present disclosure (SHMt), according to some embodiments. The introduction of MMT into SH (SPES/HA) membranes resulted in the emergence of a new peak at 30° in the XRD spectra, attributed to the presence of HA. In addition, a medium broad peak attributed to MMT appeared at a lower angle of 5.64°, corresponding to an interlayer spacing of 1.53 nm. Furthermore, the crystallinity of MMT was observed to decrease due to the expansion of the MMT layers and the increased hydrogen bonding between SH with abundant functional groups and the interlayer water of MMT layers.

FIG. 4B illustrates X-ray photoelectron spectroscopy (XPS) survey spectra of MMT powder, humic acid (HA), a sulfonated polyethersulfone (SPES) membrane, and a formed membrane of the present disclosure (SHMt), according to some embodiments. FIG. 4C illustrates high resolution scans for O 1s for a sulfonated polyethersulfone (SPES) membrane, a sulfonated polyethersulfone and humic acid membrane (SH), and a formed membrane of the present disclosure (SHMt), according to some embodiments. FIG. 4D illustrates high resolution scans for C 1s for a sulfonated polyethersulfone (SPES) membrane, a sulfonated polyethersulfone and humic acid membrane (SH), and a formed membrane of the present disclosure (SHMt), according to some embodiments.

XPS analysis was utilized to analyze the structural changes in SPES membranes after incorporating HA and intercalating SH into MMT layers. By comparing the O 1s and C 1s spectra of SPES, SH, and SHMt membranes, no significant changes were observed in the overall spectral features, suggesting that the intercalation of SH did not induce substantial alterations to the chemical composition of the SPES polymer backbone. This finding is indicative of a relative interaction between the SH polymer and MMT interlayers, involving the functional groups of HA and MMT layers. Additionally, there is a disappearance of the peaks associated with the C═O of the carboxylic group in HA. The functional groups of the HA can play an important role in promoting the intercalation process of the SPES into MMT interlayers.

HA can interact with MMT particles through a variety of mechanisms, including anion exchange at the edges of MMT particles, cation/water bridging to the MMT surface, hydrogen bonding with Si—OH groups, and van der Waals forces. These interactions can contribute to the intercalation of SH within the MMT interlayers. Furthermore, cation/water bridging and/or hydrogen bonding interactions can contribute to the formation of a more porous and interconnected structure, which can enhance ion diffusion.

Furthermore, the incorporation of MMT and HA into SPES membranes resulted in significant changes in the elemental composition as shown in Table 1. The atomic percentage of carbon decreased to 70.22 at. %, while the atomic percentages of oxygen and sulfur increased, showing the successful intercalation of the SH polymer within the MMT interlayers. This positive effect can be attributed to the abundant functional groups in HA, which promoted the intercalation process. Accordingly, these changes can have a positive impact on the selectivity and internal resistance of the membranes. The increased oxygen content, derived from the intercalated HA, can also contribute to enhanced ion transport and selectivity.

TABLE 1
The elemental composition of MMT powder, HA powder,
SPES, SH and SHMt membranes by XPS technique.

| MMT powder | | | HA powder | | SPES | | SH | | SHMt | |
|---|---|---|---|---|---|---|---|---|---|---|
| | Peak | Atomic | Peak | Atomic | Peak | Atomic | Peak | Atomic | Peak | Atomic |
| | BE | % | BE | % | BE | % | BE | % | BE | % |
| C 1s | 284.11 | 14.16 | 284.01 | 73.43 | 283.78 | 74.65 | 283.7 | 78.54 | 283.89 | 70.22 |
| O 1s | 531.43 | 56.27 | 531.45 | 22.65 | 531.02 | 17.23 | 530.87 | 15.31 | 531.09 | 20.96 |
| S 2P | | | | | 167.24 | 4.8 | 167.33 | 1.07 | 167.25 | 3.61 |
| Si 2p | 102.39 | 19.25 | | | | | | | 100.81 | 0.38 |

Furthermore, the formation of strong hydrogen bonding and electrostatic interactions between the functional groups of the SH polymer and the MMT layers can enhance the stability and durability of the intercalated structure. This can lead to improved mechanical properties and resistance to degradation, making the membranes more desirable for long-term applications.

The thermal stability of the SHMt membranes was evaluated using TGA analysis. FIG. 4E illustrates thermogravimetric analysis (TGA) for a sulfonated polyethersulfone membrane (SPES), a sulfonated polyethersulfone and humic acid membrane (2.5-SH), a MMT and sulfonated polyethersulfone membrane (10-MS), and a formed membrane of the present disclosure (SHMt), according to some embodiments. 2.5-SH represents the percentage of humic acid in the mixture (weight ratio of 100 SPES and 25 humic acid) before adding any MMT. 10-MS represents a percentage of MMT alone with SPES (weight ratio of 100 SPES and 100 MMT).

The addition of MMT enhanced the thermal resistance of the membranes. The thermal degradation of the pure SPES and SH membranes started at 565° C. and 572.5° C., respectively. However, the SHMt membrane exhibited a slightly lower thermal decomposition temperature of 560° C. Despite the slight decrease in thermal decomposition temperature, the SHMt membranes exhibited significantly higher residual weight percentages compared to the pure SPES and SH membranes. This showed that the homogeneous distribution and intercalation of the SH composite within the MMT layers enhanced the resistance to thermal degradation. The higher residual weight percentage of 49.6% in SHMt, compared to 8.5% in SPES and 42.5% in SH, shows that the MMT layers can provide a protective barrier that inhibits the degradation of the polymer chains.

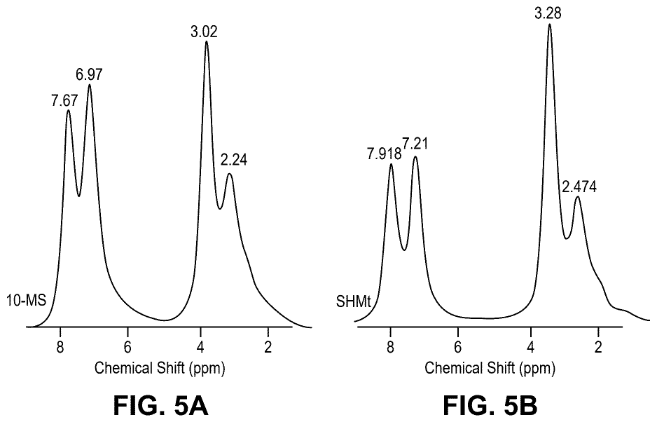

FIG. 5A illustrates proton nuclear magnetic resonance (1H-NMR) of a 10-MS membrane, according to some embodiments. FIG. 5B illustrates proton nuclear magnetic resonance (1H-NMR) of a SHMt membrane, according to some embodiments. The 1H NMR spectra of SHMt revealed a shift in the peaks of SPES to lower chemical shift values. This shift, accompanied by peak broadening and intensity changes, shows that the SPES polymer backbone has intercalated within the MMT interlayers, creating a shielding effect. The magnitude of this shift in SHMt was lower than that observed in 10-MS, showing that the intercalation process can involve interactions between the HA functional groups and the interlayer water or cations within the MMT nanosheets.

### Example 4—Osmotic Power Generation

As shown in Table 2, the incorporation of MMT into the SH polymer matrix significantly enhanced the cation selectivity and energy conversion efficiency. SHMt exhibited cation transference numbers of 0.96 attributed to the nanoconfined channels of approximately 1.5 nm that facilitated ion transport and selectivity. The nanochannel height of 1.5 nm can allow for the overlapping of electrical double layers, enhancing cation selectivity and energy conversion efficiency. SHMt achieved energy conversion efficiencies of 42.23% under 5-fold concentration gradients. Additionally, the developed membranes demonstrated lower internal fluidic transport resistances compared to the unmodified SH membranes. SHMt exhibited internal resistance of 0.0038 μΩ·m, respectively, while SH had resistance of 0.00445 μΩ·m. These lower resistances resulted in higher ionic current and power density, reaching 18.6 mW·m².

TABLE 2
Salinity gradient energy harvesting across the SHMt membranes.

| | Cation | Membrane | Pd max | Energy |
|---|---|---|---|---|
| Type of | transference | resistivity | (mW · | conversion |
| Membrane | number (t+) | (micro Ohm · m) | m − 2) | efficiency (%) |
| SHMt | 0.9595 | 0.0038 | 18.564 | 42.23 |

### Example 5—Ion Transport Characteristics and Impact of Fouling

The cation selectivity of the SHMt membrane was further assessed using IV characteristics and derived ionic current densities under various conditions. The IV characteristics and derived ionic current densities of hybrid membranes were analyzed by osmotic ion flow with varying ionic valences and spanning a wide range of effective hydrated ionic volumes. For example, the salinity gradient ion transport was investigated in the presence of foulants, such as Ni(NO₃)₂, Zn(NO₃)₂, or phenol. The incorporation of MMT into SPES and SH membranes significantly enhanced the ion selectivity and transport properties.

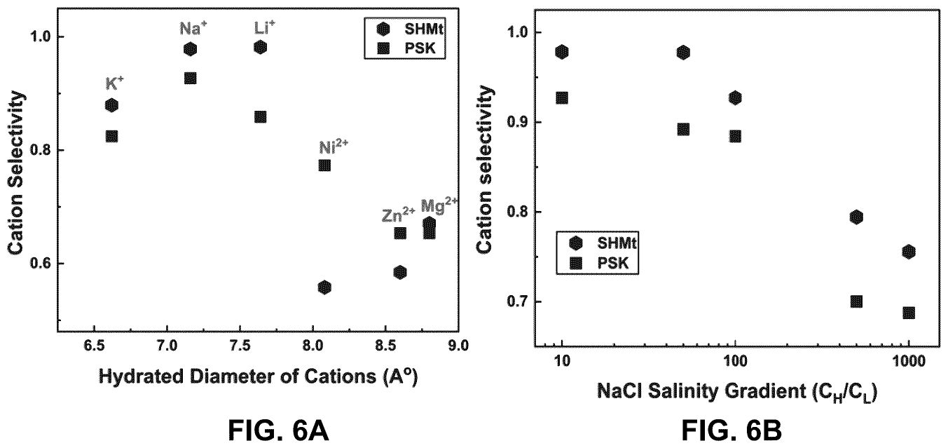

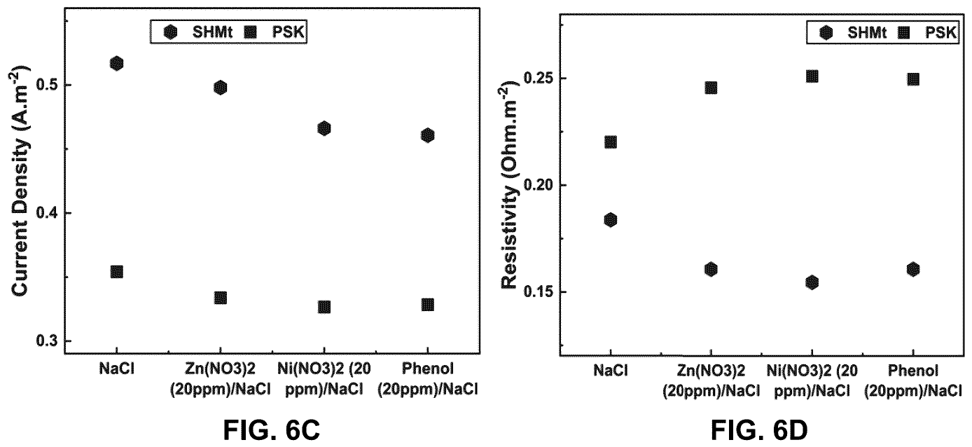

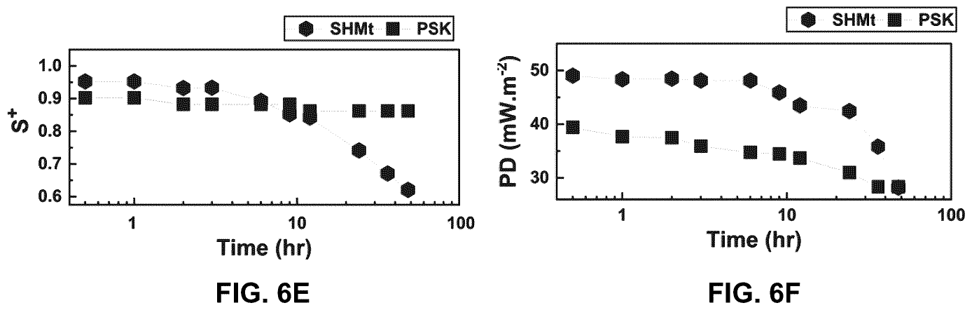

FIG. 6A illustrates cation selectivity of a SHMt membrane and a PSK cation exchange membrane against ionic species with different hydrated diameters, according to some embodiments. In one example, the SHMt membrane demonstrated a preference for monovalent cations over divalent cations, exhibiting size-dependent steric sieving and electrostatic repulsion. The smaller cations, such as Li⁺, were more readily transported through the hydrophilic pores of SHMt due to the hydrated energy, showing a slight preference for Li⁺ ions over Na⁺ ions but lower selectivity for K⁺. The lowered passage of K⁺ ions can be due to the creation of electrostatic barriers and increased hydrophobicity due to the condensation in channels.

FIG. 6B illustrates the NaCl salinity gradient-dependent cation selectivity for a SHMt membrane and a PSK cation exchange membrane, according to some embodiments. SHMt exhibited a high cation selectivity with cation selectivity of 0.98 at 50-fold. The observed decline in cation selectivity at higher salinity gradients can be attributed to factors such as reduced ionic conductivity on the low-concentration side and high-water transport through osmosis and concentration polarization.

FIG. 6C illustrates the current density for a SHMt membrane and a PSK cation exchange membrane in the presence of foulants, according to some embodiments. The ion permeation was examined under a binary system of NaCl salinity gradient of 50-fold in the presence of heavy metals with 20 ppm of Zn²⁺ or Ni²⁺ ions or organic compounds like phenol. This analysis was performed for the impact of foulants, commonly found in oilfield-PW and industrial wastewater, on the ion transport properties of the developed membranes.

FIG. 6D illustrates resistivity across a SHMt membrane and a PSK cation exchange membrane in the presence of foulants, according to some embodiments. Divalent cations such as Zn²⁺ and Ni²⁺, exhibited suppressed transport behavior compared to Na⁺. This is attributed to steric hindrance and partial dehydration, resulting from the larger hydrated ionic diameters and possible chemical adsorption onto the membrane surface. Additionally, the presence of foulants, such as phenol, can hinder the ion transport properties of the developed membranes. Phenol molecules can diffuse and adsorb onto the membrane surface through hydrogen bonding with the functional groups of the SHMt membranes. This interaction can decrease membrane conductance and ionic selectivity. While both membranes experienced a slight decline in current density and internal resistance in the presence of foulants, SHMt membranes exhibited a higher current density (0.53 A·m⁻²) compared to the PSK membrane (0.36 A·m⁻²). This is due to the lower internal resistance of SHMt membranes

FIG. 6E illustrates long-term stability (cation selectivity) of a SHMt membrane and a PSK cation exchange membrane under a salinity gradient (50-fold), according to some embodiments. FIG. 6F illustrates long-term stability (power density) of a SHMt membrane and a PSK cation exchange membrane under a salinity gradient (50-fold), according to some embodiments. The incorporation of MMT into SH membranes significantly enhanced the ion selectivity and energy conversion efficiency. SHMt membranes exhibited higher power densities of 50 mW·m⁻² compared to the PSK cation exchange membrane.

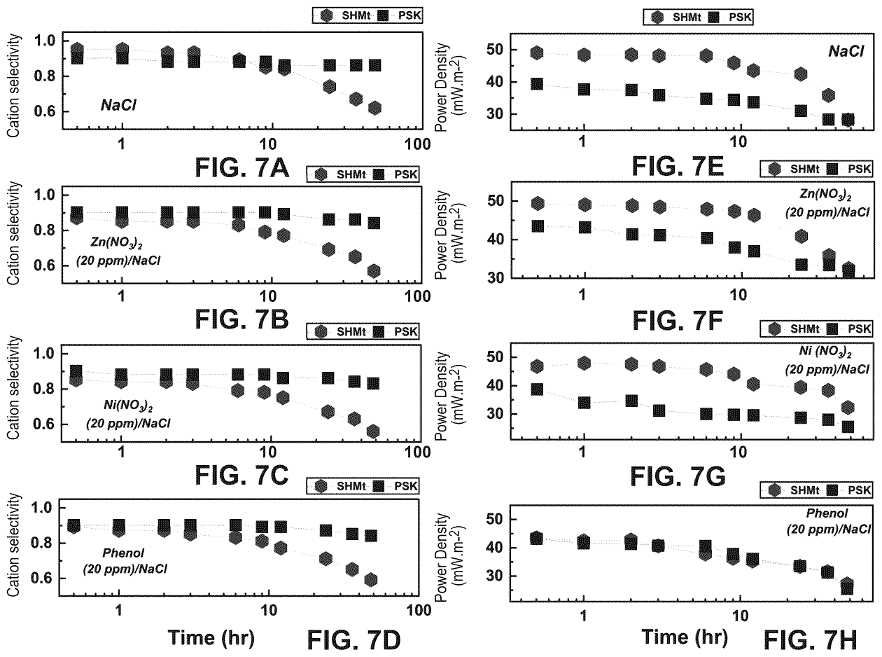

FIG. 7A illustrates long-term stability (cation selectivity) of the SHMt membranes compared to a PSK membrane, according to some embodiments. FIG. 7B illustrates long-term stability (cation selectivity) of the SHMt membranes compared to a PSK membrane, in the presence of Zn(NO₃)₂, according to some embodiments. FIG. 7C illustrates long-term stability (cation selectivity) of the SHMt membranes compared to a PSK membrane, in the presence of Ni(NO₃)₂, according to some embodiments. FIG. 7D illustrates long-term stability (cation selectivity) of the SHMt membranes compared to a PSK membrane, in the presence of phenol, according to some embodiments.

FIG. 7E illustrates long-term stability (power density) of the SHMt membranes compared to a PSK membrane, according to some embodiments. FIG. 7F illustrates long-term stability (power density) of the SHMt membranes compared to a PSK membrane, in the presence of Zn(NO₃)₂, according to some embodiments. FIG. 7G illustrates long-term stability (power density) of the SHMt membranes compared to a PSK membrane, in the presence of Ni(NO₃)₂, according to some embodiments. FIG. 7H illustrates long-term stability (power density) of the SHMt membranes compared to a PSK membrane, in the presence of phenol, according to some embodiments.

SHMt demonstrated superior cation selectivity and maintained stable power density over 48 hours, even in the presence of various foulants. This improvement can be attributed to the synergistic effects of incorporating HA and utilizing MMT, which create nanochannels within the membranes. The expanded nanoconfined channels within the hybrid material further contribute to these beneficial effects by providing a more open and accessible pathway for ion diffusion. This increased ion mobility reduces the internal resistance of the membrane, enabling more efficient charge transfer.

The intercalation of SPES polymer into MMT interlayers can be facilitated by electrostatic interactions or hydrogen bonding between the sulfonic groups of SPES and the intercalated water molecules within the MMT structure. As the amount of intercalated SPES increases, the arrangement of SPES within the MMT interlayer space can change, leading to the expansion of the MMT interlayer. These interactions between the abundant functional groups of HA (bonded to the SPES) contribute to the intercalation of SH within the MMT interlayers, leading to the further expansion of the MMT layers and facilitating faster ion transport and increased selectivity. This augmentation in interlayer spacing is facilitated through hydrogen bonding, which allows for the creation of confined ion nanochannels. These fluidic conduits can function as selective filters and ion rectifiers, enabling precise control over mass transport and energy conversion processes.

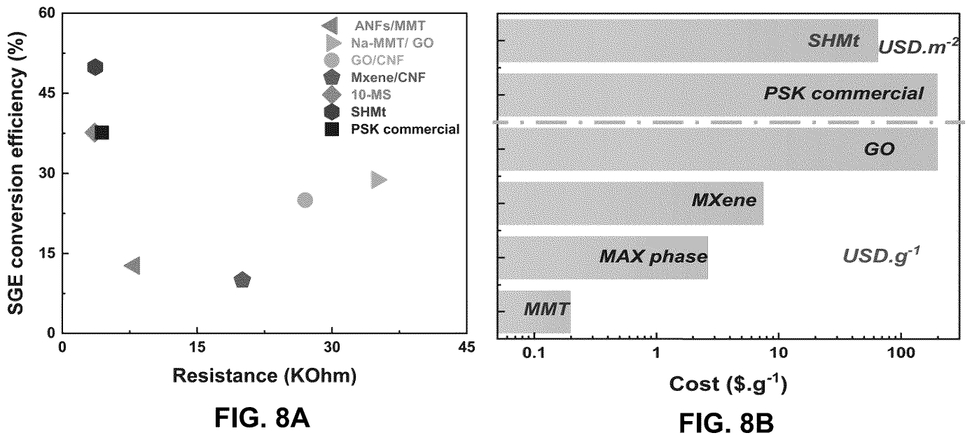

FIG. 8A illustrates a comparative plot of membrane resistivity and energy conversion efficiency of SHMt, a PSK cation exchange membrane, and other membranes, according to some embodiments. The SHMt membranes exhibited low ionic resistivity and high energy conversion efficiency, exceeding that of other types of membranes. FIG. 8B illustrates unit cost of raw nanofiller materials per mass (g) or unit cost of membranes per 1 m² area, according to some embodiments. From economic and environmental standpoints, the developed membranes of the present disclosure offer several advantages compared to other membranes, such as the availability of MMT and straightforward chemical controllability. Moreover, the method for forming the membrane of the present disclosure promotes efficient scalability of the membrane.

As described in FIG. 8B, the material cost per unit weight of the MMT is evaluated to be 0.2 USD/g, which is ten times cheaper than other nanofillers such as MAX phase powder of 2.68 USD/g, 38 times cheaper than MXene of 7.58 USD/g, and three orders of magnitude cheaper than exfoliated GO materials of around 200 USD/g. For membrane-scale evaluation, the estimated cost of the 1 m² SHMt nanocomposite membrane with a thickness of 25 μm is approximately 65.63 USD/m², which is four times less than that of a conventional ion-exchange membrane (200 USD/m²).

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A membrane, the membrane comprising:
sulfonated polyethersulfone;
humic acid; and
a layered aluminosilicate,
wherein a weight ratio of humic acid to sulfonated polyethersulfone ranges from about 20:100 to about 30:100, and a weight ratio of the layered aluminosilicate to sulfonated polyethersulfone ranges from about 90:100 to about 100:90.

2. The membrane of claim 1, wherein the layered aluminosilicate includes a 2-1 layered aluminosilicate including an octahedral sheet between two tetrahedral sheets.

3. The membrane of claim 2, wherein the 2-1 layered aluminosilicate includes at least one of montmorillonite and vermiculite.

4. The membrane of claim 1, wherein the weight ratio of humic acid to sulfonated polyethersulfone ranges from about 23:100 to about 27:100.

5. The membrane of claim 1, wherein the weight ratio of the layered aluminosilicate to sulfonated polyethersulfone ranges from about 97:100 to about 100:97.

6. The membrane of claim 1, having at least partial intercalation of the humic acid and sulfonated polyethersulfone within layers of the layered aluminosilicate.

7. The membrane of claim 1, wherein the membrane has an atomic percentage of Si based on elemental composition ranging from about 0.1% to about 1%.

8. The membrane of claim 7, wherein the membrane has an atomic percentage of S based on elemental composition ranging from about 1% to about 5%.

9. A method for forming a membrane, the method comprising:
mixing a solvent, sulfonated polyethersulfone, and humic acid to form a first mixture;
adding a 2-1 layered aluminosilicate to the first mixture to form a second mixture, the 2-1 layered aluminosilicate including a layered structure with an octahedral sheet between two tetrahedral sheets;
casting the second mixture; and
evaporating the solvent to form a product membrane.

10. The method of claim 9, wherein the solvent includes N-methyl-2-pyrrolidone (NMP).

11. The method of claim 9, wherein the 2-1 layered aluminosilicate includes at least one of montmorillonite and vermiculite.

12. The method of claim 9, wherein a weight ratio of humic acid to sulfonated polyethersulfone in the product membrane is greater than 20:100.

13. The method of claim 9, wherein a weight ratio of humic acid to sulfonated polyethersulfone in the product membrane ranges from about 20:100 to about 30:100.

14. The method of claim 9, wherein a weight ratio of the 2-1 layered aluminosilicate to sulfonated polyethersulfone in the product membrane ranges from about 90:100 to about 100:90.

15. The method of claim 9, wherein the product membrane exhibits at least partial intercalation of the humic acid and sulfonated polyethersulfone within layers of the 2-1 layered aluminosilicate.

16. The method of claim 9, wherein the product membrane has an atomic percentage of Si based on elemental composition ranging from about 0.1% to about 1%; and the product membrane has an atomic percentage of S based on elemental composition ranging from about 1% to about 5%.

17. A reverse electrodialysis system, the reverse electrodialysis system comprising:
an anode;
a cathode;
one or more anion exchange membranes; and
one or more cation exchange membranes, the one or more cation exchange membranes including a plurality of sulfonated polymers, humic acid, and montmorillonite, wherein a weight ratio of humic acid to the plurality of sulfonated polymers in the one or more cation exchange membranes ranges from about 20:100 to about 30:100.

18. The reverse electrodialysis system of claim 17, wherein the weight ratio of humic acid to the plurality of sulfonated polymers in the one or more cation exchange membranes ranges from about 23:100 to about 27:100.

19. The reverse electrodialysis system of claim 17, wherein a weight ratio of montmorillonite to the plurality of sulfonated polymers in the one or more cation exchange membranes ranges from about 90:100 to about 100:90.

20. The reverse electrodialysis system of claim 17, wherein the plurality of sulfonated polymers includes sulfonated polyethersulfone, and the one or more cation exchange membranes exhibits at least partial intercalation of the humic acid and sulfonated polyethersulfone within layers of the montmorillonite.
